(19) United States
(12) Patent Application Publication
(10) Pub. No.: US 2008/0189598 A1
(43) Pub. Date: Aug. 7, 2008

(54) ELECTRONIC FILING SYSTEM

(76) Inventor: Hajime Yoshida, Nara (JP)

Correspondence Address: BIRCH STEWART KOLASCH & BIRCH, PO BOX 747, FALLS CHURCH, VA, 22040-0747, US

(21) Appl. No.: 12/026,965

(22) Filed: Feb. 6, 2008

(30) Foreign Application Priority Data
Feb. 7, 2007 (JP) 2007-028411

(51) Int. Cl. G06F 17/00

(52) U.S. Cl. 715/227

(57) ABSTRACT

The electronic filing system used in an embodiment of the present invention, which is an electronic filing system provided with a document file presentation means for presenting a user with a list of saved document files, is provided with a cost table specifying costs incurred by printing or communication in accordance with print configuration or communication configuration conditions and a calculation means for calculating costs incurred by printing or communication by referring to the cost table. Here, the calculation means is adapted to refer to the cost table to calculate the costs incurred by printing or communication in accordance with a current print configuration or communication configuration in association with icons of the document files displayed as the list by the document file presentation means and display the calculated costs as the costs incurred by printing or communicating the document files corresponding to the icons.

This application claims priority rights under Section 119(a) of the U.S. Patent Law from Japanese Patent Application No. 2007-028411 filed on Feb. 7, 2007 in Japan. Its entire contents are incorporated herein by reference.

### BACKGROUND OF THE INVENTION

1. Field of the Invention

The present invention relates to an electronic filing system provided with a means for presenting a user with a list of saved document files and a list of binders, cabinets and other virtual storage devices used to group them.

2. Description of the Related Art

Various types of electronic filing software have been proposed as technology for electronically saving and managing documents on paper media and document data created by common applications. The approach taken by these electronic filing software titles consists in saving entered document data in virtual file storage devices, with operations on such virtual file storage devices performed with the help of a personal computer (PC) display or a user interface displayed on a device's operator panel.

Past attempts at enhancing the usability of the user interfaces employed in handling virtual file storage devices have focused on displaying the storage devices themselves as icons (metaphors), assigning and displaying labels/titles, displaying information on the storage capacity of the storage devices, etc.

For example, JP2002-157274A proposed an electronic filing device that made memories related to the documents of the user available for use based on images involving taking files from shelves or lockers etc. and reading the documents contained therein, which was accomplished by saving a cover collection file of document data in association with file display locations in images of files in virtual storage devices such as shelves or lockers etc. or images of files made up of a set of only external images of files and making it possible for the necessary documents to be selected from the cover collection file.

However, both in existing services and in the type of service described in JP2002-157274A mentioned above, the user could not easily obtain cost-related information and other information in advance, prior to the execution of a job (printing, transmitting a facsimile, sending an e-mail, etc.).

In general, a virtual storage device is used to save multiple document files, with each file including multiple pages. Furthermore, in case of a typical fee-based service, the fee varies depending on whether the pages are black-and-white or color, and, consequently, there is a difference in fees depending on whether the pages contain color images or monochromatic images. Therefore, labor-intensive operations involving manually counting the number of pages separately for black-and-white and color pages and computing the fees were required if a user wanted to estimate the cost of a job prior to its execution.

In addition, it is believed that existing services permit configuration of quality and various other settings used when printing, transmitting facsimiles (faxes), and sending e-mails, with the cost of job execution varying in accordance with such settings. However, since it is not easy for a user to quickly figure out the cost, which varies under these various configuration conditions, it has been difficult to configure optimal settings corresponding to the desired quality while keeping the budget in mind.

### SUMMARY OF THE INVENTION

The present invention was made with account taken of the above circumstances and its object is to provide an electronic filing system capable of notifying the user of the cost of printing or communicating document files displayed in a list in accordance with various print configuration conditions or communication configuration conditions.

The electronic filing system of the present invention is an electronic filing system provided with a document file presentation means for presenting a list of saved document files to a user, the electronic filing system comprising a printing cost table specifying printing costs according to print configuration conditions, and a printing cost calculation means for calculating printing costs by referring to the printing cost table, wherein the printing cost calculation means refers to the printing cost table to calculate printing costs corresponding to a current print configuration in association with icons of the document files displayed as the list by the document file presentation means and displays the calculated printing costs as the printing costs of the document files corresponding to the icons.

In other words, by referring to the printing cost table, the printing cost calculation means calculates printing costs corresponding to the pre-set current print configuration conditions in association with the icons of the document files displayed as a list by the document file presentation means. The printing cost table is used to store per-page printing costs (unit prices) for each of the print configuration conditions, such as, for instance, resolution, color mode, paper size, etc. Accordingly, when a given document file is printed, a printing cost for the document file is calculated in the printing cost calculation means with the help of a module called a “virtual printer” by computing the number of pages produced in case of printing under the print configuration conditions used for the document file and multiplying the number of pages by the above-mentioned printing costs (unit prices). The calculated printing costs are then displayed as the printing costs of the document files corresponding to the icons. As for the display format, the costs can be displayed, for instance, by appending tags to the icons. Thus, the printing cost of document files can be made known in advance prior to print job execution by displaying, in association with the icons of the listed document files, the cost of printing of the document files in accordance with the current print configuration. This makes it possible for the user to minimize an increase in printing costs due to a print configuration involving excessive volumes or excessive quality.

Furthermore, the electronic filing system of the present invention may also be the electronic filing system provided with a storage device presentation means for presenting the user with a list of storage devices used to group and store the saved document files, the electronic filing system comprising the printing cost table specifying printing costs according to print configuration conditions and the printing cost calculation means for calculating printing costs by referring to the printing cost table, wherein the printing cost calculation means refers to the printing cost table to calculate printing costs corresponding to the current print configuration in association with icons of the storage devices displayed as the list by the storage device presentation means and displays the calculated printing costs as the printing costs of all the document files contained in the storage devices.

In other words, by referring to the printing cost table, the printing cost calculation means calculates printing costs corresponding to a current print configuration in association with the icons of binders, cabinets, and other storage devices listed by the storage device presentation means. The printing cost table is used to store per-page printing costs (unit prices) for each of the print configuration conditions, such as, for instance, resolution, color mode, paper size, etc. Accordingly, when all the document files contained in a given icon are printed, the printing cost (total printing cost) of all the document files contained in the icon is calculated in the printing cost calculation means with the help of a module called a “virtual printer” by computing the number of pages produced for all the document files in case of printing under the print configuration conditions and multiplying the total number of pages by the above-mentioned printing costs (unit prices). The calculated total printing cost is then displayed as the printing cost of all the document files contained in a storage device. As for the display format, the costs can be displayed, for instance, by appending tags to the icons. Thus, the total printing cost of a group of document files produced by grouping can be made known to the user in advance by displaying, in association with the icons of the listed storage devices, the total printing cost of all the document files contained in the storage devices in accordance with the current print configuration. This enables the user to minimize the labor required to compute the printing costs by manually scanning the contents of the storage devices.

Moreover, in the electronic filing system according to the present invention, multiple icons may be made simultaneously selectable by successively pointing to some or all of the multiple icons displayed as the list. The electronic filing system may be arranged to subsequently display a total printing cost incurred when printing all the multiple documents corresponding to the group of selected icons. Such an arrangement also makes it possible to easily simulate and confirm the total cost of printing of multiple ungrouped documents in the storage structures of the system that would be incurred when the multiple documents are combined and permits quick determination of the optimum combination of print settings while staying within the budget.

Moreover, the electronic filing system according to the present invention may be arranged to batch print all the documents corresponding to single or multiple icons selected by the user from the listing display. Such an arrangement makes it possible to minimize the labor required to repeatedly manually print multiple document files.

Moreover, the electronic filing system according to the present invention may be arranged to display information on the number of pages output when the documents corresponding to the group of selected icons are printed out under the current print configuration. With such an arrangement, it is possible to know in advance the number of pages that an actual printed product will have when obtained. As a result, effects in terms of minimizing the number of output pages can be expected and consumption of paper and toner can be minimized.

Moreover, the electronic filing system according to the present invention may be arranged to display information on the thickness and weight of all the paper media output when the documents corresponding to the group of selected icons are printed out under the current print configuration. Such an arrangement makes it possible to know the weight and thickness that an actual printed product will have when obtained. As a result, the waste of storage space due to excessive printing volumes can be minimized and consumption of paper and toner can be minimized.

Moreover, the electronic filing system according to the present invention may be arranged to display costs incurred when the paper media that have been printed out are placed in an envelope and mailed using a mailing service as well. Since such an arrangement makes it possible to display the mailing fees of the mailing service as well, the user can figure out the total cost expected when mailing the output paper copy.

Furthermore, the electronic filing system of the present invention may also be an electronic filing system provided with a document file presentation means for presenting a list of saved document files to a user, the electronic filing system comprising a communication cost table specifying communication costs according to communication configuration conditions, and a communication cost calculation means for calculating communication costs by referring to the communication cost table, wherein the communication cost calculation means refers to the communication cost table to calculate communication costs corresponding to the current communication configuration in association with icons of the document files displayed as the list by the document file presentation means and displays the calculated communication costs as the communication costs of the document files corresponding to the icons.

In other words, by referring to the communication cost table, the communication cost calculation means calculates communication costs corresponding to the pre-set current communication configuration conditions in association with the icons of document files listed by the document file presentation means. The communication cost table is used to store per-page or per-address communication costs (unit prices) for each of the communication configuration conditions, such as, for instance, resolution, original, compression scheme, etc. Accordingly, when a given document file is transmitted, a communication cost for the document file is calculated in the communication cost calculation means by computing the number of pages involved when effecting communication under the communication configuration conditions of the document file by substituting therefor the number of pages obtained when printing with the help of a module called a “virtual printer” and then multiplying the number of pages by the above-mentioned communication costs (unit prices). The calculated communication costs are then displayed as the communication costs of the document files corresponding to the icons. As for the display format, the costs can be displayed, for instance, by appending tags to the icons. Thus, the cost required for transmitting a fax or sending an e-mail can be made known by displaying, in association with the icons of the listed document files, the communication costs of the document files in accordance with the current communication configuration. This enables the user to minimize an increase in communication costs due to a fax transmission configuration or e-mail transmission configuration involving excessive volumes or excessive quality.

Furthermore, the electronic filing system of the present invention may also be the electronic filing system provided with a storage device presentation means for presenting the user with a list of storage devices used to group and store the saved document files, the electronic filing system comprising the communication cost table specifying communication costs according to communication configuration conditions and the communication cost calculation means for calculating communication costs by referring to the communication cost table, wherein the communication cost calculation means refers to the communication cost table to calculate communication costs corresponding to the current communication configuration in association with icons of the storage devices displayed as the list by the storage device presentation means and displays the calculated communication costs as the communication costs of all the document files contained in the storage devices.

In other words, by referring to the communication cost table, the communication cost calculation means calculates communication costs corresponding to the current communication configuration in association with the icons of binders, cabinets, and other storage devices listed by the storage device presentation means. The communication cost table is used to store per-page or per-address communication costs (unit prices) for each of the communication configuration conditions, such as, for instance, resolution, original, compression scheme, etc. Accordingly, when all the document files contained in a given icon are communicated, a communication cost (total communication cost) for all the document files contained in the icon is calculated in the communication cost calculation means by computing, for all the document files, the number of pages produced when effecting communication under the communication configuration conditions used for all the document files by substituting therefor the number of pages produced when printing with the help of a module called a “virtual printer” and then multiplying the total number of pages by the above-mentioned communication costs (unit prices). The calculated total communication cost is then displayed as the communication cost of all the document files contained in the storage device. As for the display format, the costs can be displayed, for instance, by appending tags to the icons. Thus, the cost required for transmitting a fax or sending an e-mail can be made known by displaying, in association with the icons of the listed storage devices, the total communication cost of all the document files contained in the storage devices in accordance with the current communication configuration. This enables the user to minimize the labor required to compute the communication costs by manually scanning the contents of the storage devices.

Moreover, in the electronic filing system according to the present invention, multiple icons may be made simultaneously selectable by successively pointing to some or all of the multiple listed icons. The system may be arranged to subsequently display a total communication cost of transmitting all the multiple documents corresponding to the group of selected icons. Such an arrangement also makes it possible to easily simulate and confirm the total communication cost of multiple ungrouped documents in the storage structures of the system that would be incurred when the multiple documents are combined and permits quick determination of the optimum combination of communication configuration settings that is within the budget.

Moreover, the electronic filing system according to the present invention may be arranged to batch transmit all the documents corresponding to single or multiple icons selected by the user from the listing display. Such an arrangement makes it possible to minimize the labor required to repeatedly manually transmit multiple document files.

Moreover, the electronic filing system according to the present invention may be arranged to display icons with a size of the displayed icons reduced or increased in accordance with an internal volume of the storage devices. Such an arrangement makes it possible to more intuitively grasp the amount of data held in a target storage device or the number of pages that a document will have when an actual printed product is obtained.

Moreover, in accordance with the electronic filing system of the present invention, when costs required for an execution of various jobs are displayed, costs incurred when, for each of the several different job configurations selected and registered by the user in advance, a job is executed under the job configuration, are displayed as a list, and parameter groups of the job configuration are automatically set up and job execution is initiated when the user selects one of the job configurations. With such an arrangement, costs corresponding to frequently used combinations of parameters are displayed as a list, and, as a result, usability is further improved because parameters can be set automatically when the user selects a single preferred combination from among the combinations.

Moreover, the electronic filing system according to the present invention may be arranged to present combinations of parameter settings permitting job execution on selected documents in accordance with a fee cap designated by the user in advance. Such an arrangement makes it possible to minimize the labor required of the user to manually search for a combination of print configuration, fax communication configuration, or e-mail communication configuration options involving quality and costs that are within the budget.

Moreover, the electronic filing system according to the present invention may be arranged such that, on a user interface utilized for configuring various job and parameter settings and comprising pull-down menus, radio buttons, and check boxes, the electronic filing system, in addition to titles of respective selectable values, displays job execution fees associated with combinations of parameters applied in cases where the configuration settings are changed to the values. Such an arrangement makes it possible to minimize the labor required to successively check cost changes by adjusting the print configuration, fax communication configuration, or e-mail communication configuration.

Moreover, the electronic filing system according to the present invention may be arranged such that, on a user interface utilized for configuring various job and parameter settings and comprising pull-down menus, radio buttons, and check boxes, the electronic filing system, in addition to titles of respective selectable values, displays fee differentials relative to pre-adjustment job execution fees associated with combinations of parameters applied in cases where the configuration settings are changed to the values. Such an arrangement makes it possible to easily recognize cost-effectiveness.

### BRIEF DESCRIPTION OF THE DRAWINGS

FIG. 1 is a block diagram illustrating the electrical configuration of an electronic filing system according to an embodiment of the present invention.

FIG. 2 is an explanatory diagram illustrating an exemplary configuration of a user interface screen displayed by a display unit in an electronic filing system according to an embodiment of the present invention.

FIG. 3 is an explanatory diagram illustrating another exemplary configuration of a user interface screen displayed by a display unit in an electronic filing system according to an embodiment of the present invention.

FIG. 4 is an explanatory diagram illustrating an exemplary configuration of a user interface screen displayed when ordinary storage devices are utilized in an electronic filing system according to an embodiment of the present invention.

FIG. 5 is a diagram illustrating an exemplary configuration of a printing cost table utilized in an electronic filing system according to an embodiment of the present invention.

FIG. 6 is a diagram illustrating an exemplary configuration of a communication cost table utilized in an electronic filing system according to an embodiment of the present invention.

FIG. 7 is a diagram illustrating an exemplary configuration of a paper media physical parameter table utilized in an electronic filing system according to an embodiment of the present invention.

FIG. 8 is a diagram illustrating an exemplary configuration of a mailing fee table (for domestic destinations) utilized in an electronic filing system according to an embodiment of the present invention.

FIG. 9 is a diagram illustrating an exemplary configuration of a mailing fee table (for international destinations) utilized in an electronic filing system according to an embodiment of the present invention.

FIG. 10 is an explanatory diagram illustrating a print setup screen (main screen) used to set up a page processing method utilized during printing in an electronic filing system according to an embodiment of the present invention.

FIG. 11 is an explanatory diagram of a paper media setup screen used to set up a page processing method utilized during printing in an electronic filing system according to an embodiment of the present invention.

FIG. 12 is a flow chart to explain the most basic processing procedure involved in the calculation of printing costs in an electronic filing system according to an embodiment of the present invention.

FIG. 13 is an explanatory diagram of a basic fax setup (page processing setup) screen used to set up a page processing method utilized during fax transmission in an electronic filing system according to an embodiment of the present invention.

FIG. 14 is an explanatory diagram of a fax destination selection screen used to set up a page processing method utilized during fax transmission in an electronic filing system according to an embodiment of the present invention.

FIG. 15 is a flow chart to explain the processing procedure involved in the calculation of fax transmission costs in an electronic filing system according to an embodiment of the present invention.

FIG. 16 is an explanatory diagram of a basic e-mail transmission setup (page processing setup) screen used to set up a page processing method utilized during e-mail transmission in an electronic filing system according to an embodiment of the present invention.

FIG. 17 is an explanatory diagram of an e-mail destination selection screen used to set up a page processing method utilized during e-mail transmission in an electronic filing system according to an embodiment of the present invention.

FIG. 18 is a flow chart to explain the processing procedure involved in the calculation of e-mail transmission costs in an electronic filing system according to an embodiment of the present invention.

FIG. 19 is an explanatory diagram illustrating an exemplary configuration of a destination selection screen utilized when calculating mailing fees in an electronic filing system according to an embodiment of the present invention.

FIG. 20 is an explanatory diagram illustrating an exemplary display of printing fees used when the user registers “Frequently Used Configurations” in advance in an electronic filing system according to an embodiment of the present invention.

### DESCRIPTION OF THE PREFERRED EMBODIMENTS

Embodiments of the present invention are described below with reference to drawings.

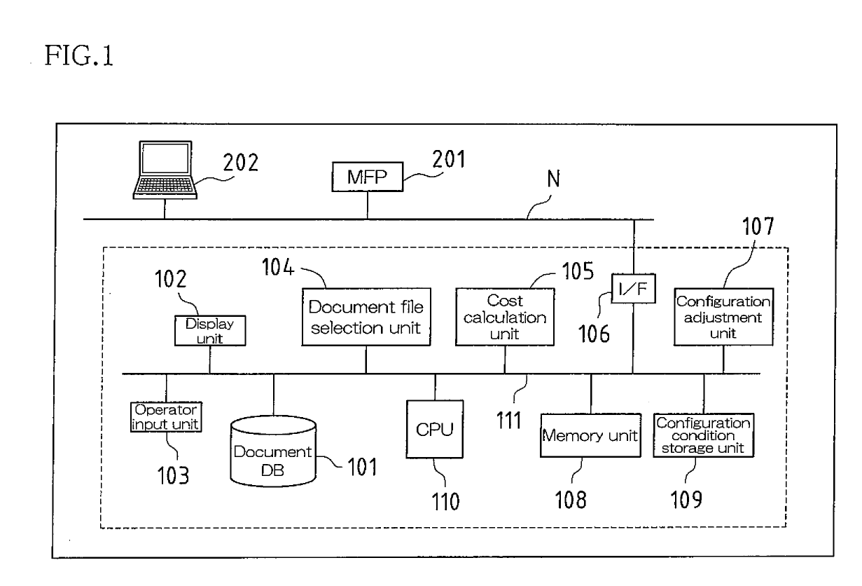

FIG. 1 is a block diagram illustrating the electrical configuration of an electronic filing system according to an embodiment of the present embodiment.

The present embodiment, which is an electronic filing system having a document file presentation feature for presenting a user with a list of document files saved in virtual storage devices, is composed, broadly, of a document database 101, a display unit 102 constituted by a LCD or TFT, etc., an operator input unit 103 comprising a mouse, a keyboard, or a touch panel, located on the display unit 102, etc., a document file selection unit 104, a cost calculation unit 105 used for calculating printing costs and communication costs, an external interface (I/F) unit 106, a configuration adjustment unit 107 used for adjusting the print configuration and communication configuration, a memory unit 108 used for storing various cost data on printing costs and communications costs, etc., a configuration condition storage unit 109 used for storing configured printing conditions and communication conditions, a control unit 110 comprising a CPU, a ROM, a RAM, etc. and controlling all the units, and a data bus 111. The data bus 111 transmits information (data signals) sent and received between the units of this system.

Moreover, the external interface (I/F) unit 106 can be connected to other communication devices, such as a personal computer 202 or an MFP (multi-functional peripheral) 201 serving as an image-forming device, by way of a network such as a LAN, a WAN, the Internet, etc. (“N” in FIG. 1).

In the above-described arrangement, in response to instructions from the operator input unit 103, the control unit 110 reads document files saved in the document file database 101 and displays the read document files in list form on the display unit 102. To work with the displayed document files, the user operates the operator input unit 103, clicking on icons displayed on the display unit 102, and, as a result, the document file selection unit 104 selects the desired document files. As a result, the cost calculation unit 105 calculates printing costs or communication costs for all the documents selected by the document file selection unit 104 based on the current print configuration conditions and communication configuration conditions stored in the configuration condition storage unit 109 and on the cost data stored in the memory unit 108 on a per-page basis (including on a per-address basis in case of communication) and displays the costs required for the printing or communication of the selected document files on the display unit 102. In such a case, the user can adjust the content (conditions) of the print configuration and communication configuration with the help of the configuration adjustment unit 107.

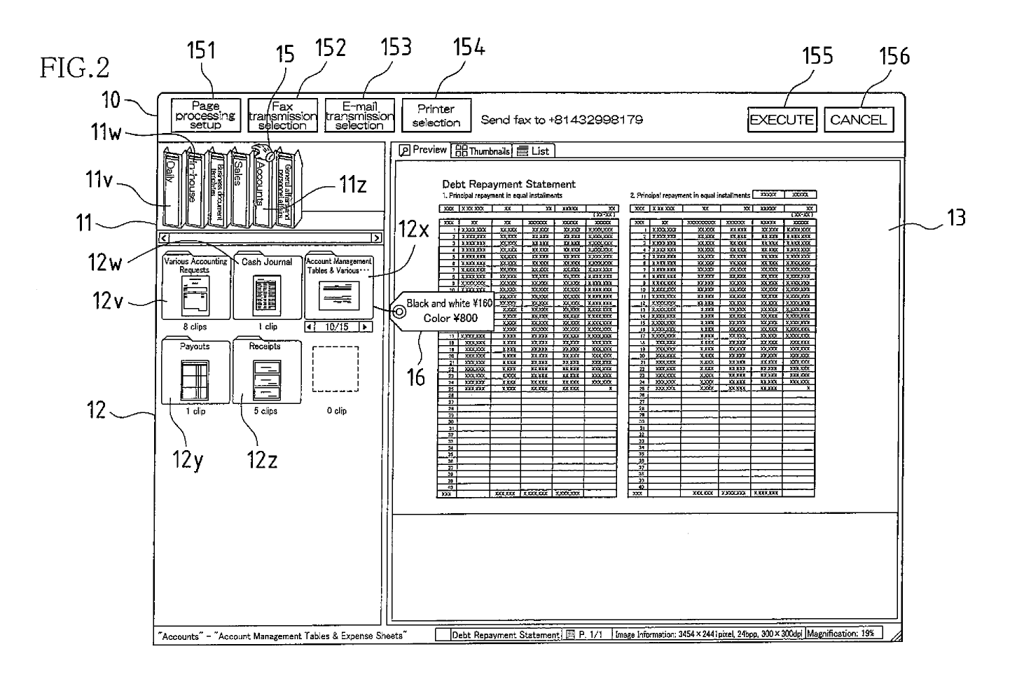

FIG. 2, which is an explanatory diagram illustrating an exemplary configuration of a user interface screen displayed on the display unit 102, shows an exemplary display of images of storage devices and costs required for the communication (transmitting or mailing, etc.) and printing of the document files contained in the storage devices. Costs required for printing are displayed in the example here.

Namely, images of storage structures such as binders 11v, 11w, . . . stored in a cabinet in a top left column 11 of the screen. This example shows a state, in which there are six binders stored in the cabinet and a binder 11z, “Accounts”, has been selected by a manipulating icon 15.

Moreover, images of storage structures such as files 12v, 12w . . . which are contained in the binder 11z “Accounts”, are displayed in a bottom left column 12 of the screen. This example shows a state, in which there are five files contained in it and a file 12x, “Account Management Tables . . . ”, has been selected. The file 12x contains 15 pages of data.

Furthermore, it shows a state, in which a preview of page No. 10 contained in the file 12x of the “Account Management Tables . . . ” selected from the bottom left column 12 of the screen is displayed in a right-hand column 13 of the screen. By switching tabs, this area can show a list, in which case the attributes of all the pages in the folder are displayed. The user selects the pages subject to printing or transmission from the binders 11v, 11w, . . . displayed in the top left column 11 of the screen and files 12v, 12w, . . . displayed in the bottom left column 12 of the screen.

Moreover, a tag 16, which displays a cost (hereinafter referred to as a “fee”) incurred when printing or communicating (transmitting or mailing, etc.) all the pages contained in the file 12x of the “Account Management Tables . . . ”, is displayed on the screen, appended to the file 12x. Although in this exemplary display, fees are displayed for each of the two print settings (black-and-white and color), when a choice between either “black-and-white” or “color” is made during color mode selection, the tag 16 may be set to display only the fee for the selected setting. Alternatively, both fees may be displayed “as is”, e.g. by displaying the fee for the selected setting in black color and the fee for the non-selected setting in gray color.

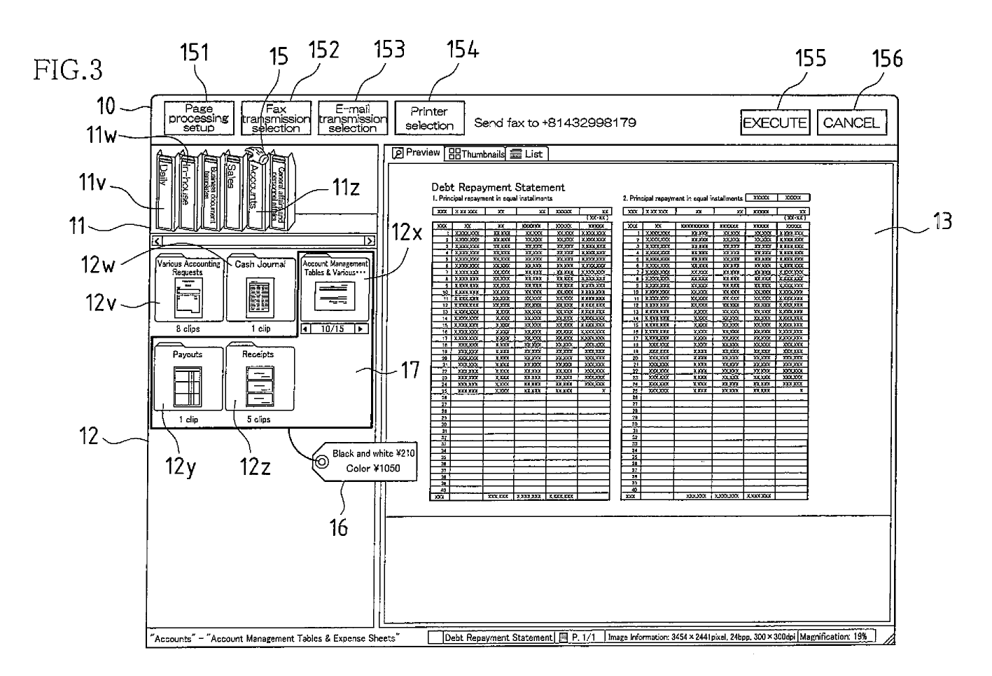

Moreover, when multiple files are selected from the bottom left column 12 of the screen, the selected files may be encircled (alternatively, the display color of this area is changed), as shown in FIG. 3, thereby highlighting the selected files, and a tag 16 may be displayed appended to this area 17, with the tag 16 displaying a total fee for printing or communicating (transmitting or mailing, etc.) all the selected files. In addition, instead of encircling the selected files in this manner where they are located, it is also possible to separately provide an area, not shown, for displaying all the selected files (e.g. in the empty portion at the bottom of the lower left column 12 of the screen, etc.) and displaying a tag indicating a total amount charged for printing or communicating (transmitting or mailing, etc.) all these files.

It should be noted that, as concerns the technique used to select multiple files from the lower left column 12 of the screen, it will suffice to successively perform operations involving operating the mouse etc. of the operator input unit 103 to move the onscreen cursor (pointer) over the desired document files and clicking on them, thereby selecting the clicked document files as documents to be printed. Alternatively, it will suffice to successively perform operations involving operating the mouse etc. of the operator input unit 103 to move the onscreen cursor (pointer) over the desired document files and allowing it to remain there for a predetermined time (e.g. 1 second, etc.), thereby selecting the document files that are pointed to as documents to be printed.

Furthermore, when multiple binders 11v, 11w, . . . in the top left column 11 of the screen are selected, an area (not shown) can be separately provided for displaying the selected binders and the total amount charged for printing or communicating (transmitting or mailing, etc.) all the files contained in all these binders can be displayed there in tag form.

Furthermore, a page processing setup button 151, which is used to open a configuration dialog dealing with various types of processing carried out when a group of selected pages is printed or transmitted, a fax transmission selection button 152, which is used to change the output mode to fax transmission and to display a dialog for configuring the destination, an e-mail transmission selection button 153, which is used to change the output mode to e-mail transmission and to display a dialog for configuring the destination, a printer selection button 154, which is used to change the output mode to printing, an “EXECUTE” button 155, which is used to execute printing or transmission, and a “CANCEL” button 156, which is used to terminate this piece of software, are displayed in an uppermost column 10 of the screen. It should be noted that while a dialog used for printer selection may be displayed when the system is used in an office setting, it is usually unnecessary when it is used in a regular convenience store.

Furthermore, while the binders 11v, 11w . . . displayed in the top left column 11 of the screen are displayed as having the same thickness, they may also be displayed by making them appear thicker or thinner depending on the volume (number of pages) of the binders 11v, 11w . . . . Such an arrangement makes it possible to more intuitively grasp the amount of data held in a target binder or the number of pages that a document will have when an actual printed product is obtained.

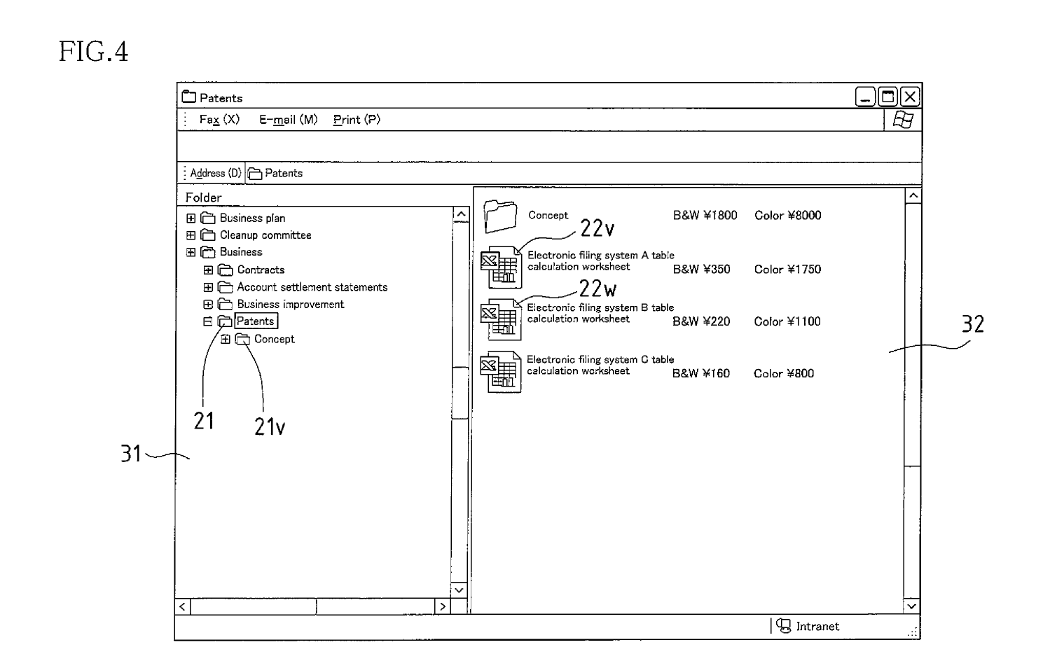

FIG. 4 shows a user interface screen displayed when ordinary storage devices are utilized. Namely, the hierarchical folder structure of a typical file system, such as that of a USB memory device, etc., is displayed on a left-hand column 31 of the screen. In this example, a listing of the contents of a subfolder 21v contained in a folder 21 “Patents” is displayed on a right-hand column 32 of the screen, with information on the costs of printing or communication (transmission or mailing, etc.) displayed next to files 22v, 22w, . . . contained in the subfolder 21v. The example herein shows printing costs. The printing cost information (i.e. printing fees), which is obtained by analyzing the files and computing the number of pages based on predetermined print settings (e.g. “2-up” etc.), is displayed in the form of file properties for each file. This display, however, is merely an example, and it can also be displayed in tag form as shown in FIG. 2 and FIG. 3.

In the electronic filing system of the present embodiment as described above, the document files stored in the document database 101 are managed hierarchically in the form of “binders”→“folders”→“pages”. As used herein, the lowermost term “pages” refers to the image data of the pages obtained when the original documents of the entered document files are printed under predetermined settings with the help of a module called a “virtual printer”. As a result, the calculation of per-page costs (fees) can be made extremely fast. The term “storage device” used in the claims refers to the “binders” or “folders” of the present embodiment.

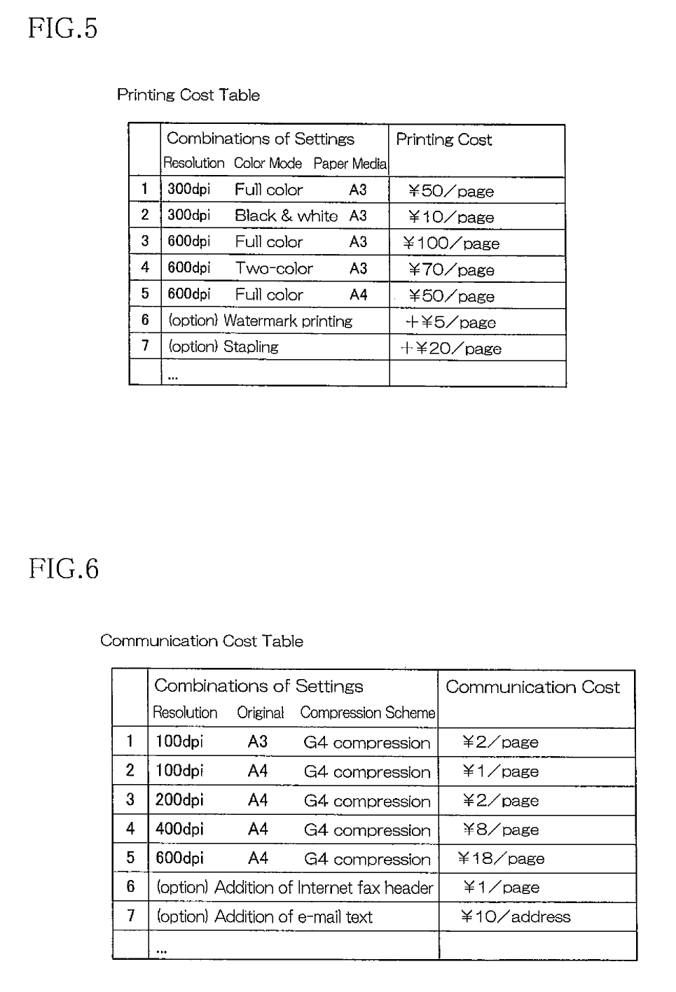

FIG. 5 illustrates an exemplary configuration of a printing cost table stored in the memory unit 108, and FIG. 6 illustrates an exemplary configuration of a communication cost table that is also stored in the memory unit 108 and has to do with fax communications, email (Internet fax) communications, etc.

In the printing cost table shown in FIG. 5, there are three types of print settings, i.e. resolution, color mode, and paper media, with printing costs set up for each respective combination of the above. For instance, the cost of full-color printing on A3 paper at a resolution of 300 dpi is ¥50/sheet, while the cost of black-and-white printing on A3 paper at a resolution of 300 dpi is ¥10/sheet. Furthermore, other types of processing, such as watermark printing and stapling, can be set up as well, and printing costs are also set up for cases, in which these conditions are configured. When these conditions are additionally configured, they are added to the above-mentioned per-page printing costs.

Moreover, in the communication cost table shown in FIG. 6, which deals with fax communications and e-mail (Internet fax) communications, there are three types of settings, i.e. resolution, original, and compression scheme, with communication costs set up for each respective combination of the above. For instance, the cost of communication (transmission) using A3 paper at a resolution of 100 dpi under the G4 compression scheme is ¥2/sheet (page) and the cost of communication (transmission) using A4 paper at a resolution of 100 dpi under the G4 compression scheme is ¥1/sheet (page). Moreover, costs are also set up for other types of processing, such as in case of adding a header or in case of adding e-mail text, with the costs added to the above-described page communication costs when such conditions are additionally configured. The addition of e-mail text is done on a per-address basis. In other words, in the present embodiment, the communication fee scheme assumes that the fees are set up on a per-page basis or on a destination address basis. However, the system is not limited to such a fee scheme and can employ fee schemes of various kinds in accordance with the economic laws.

Moreover, communication (transmission) of document data (PDFs created from text, etc.) during e-mail communication may be subdivided into cases in which data files are transmitted “as is” and cases in which they are transmitted after conversion to images for printing. In the latter case, images are converted to images for printing (PDF images, TIFF, etc.) with the help of a module called a “virtual printer” and transmitted in file attachment form, etc. When the original size and resolution used in the communication settings do not match the settings recorded in the document file itself, appropriate zooming is carried out by the virtual printer. It should be noted that although in case of the filing system provided as an example in the present invention the “page” data already correspond to print image data, the data is converted again with the help of the virtual printer in order to reflect the original size and resolution used in the communication settings.

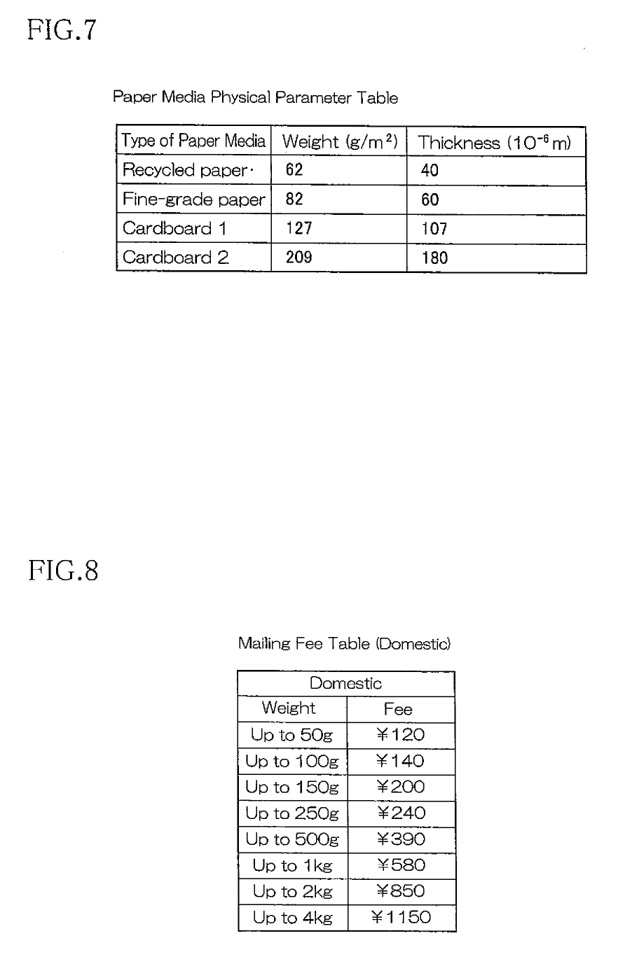

FIG. 7 illustrates an exemplary configuration of a paper media physical parameter table listing the physical parameters of the paper media stored in the memory unit 108. Namely, there are four types of paper media, i.e. recycled paper, fine-grade paper cardboard 1, and cardboard 2, with a certain weight and thickness associated with each type. However, the system is not limited to using these four types of paper media and regular paper, etc. may also be set up as a type of paper media.

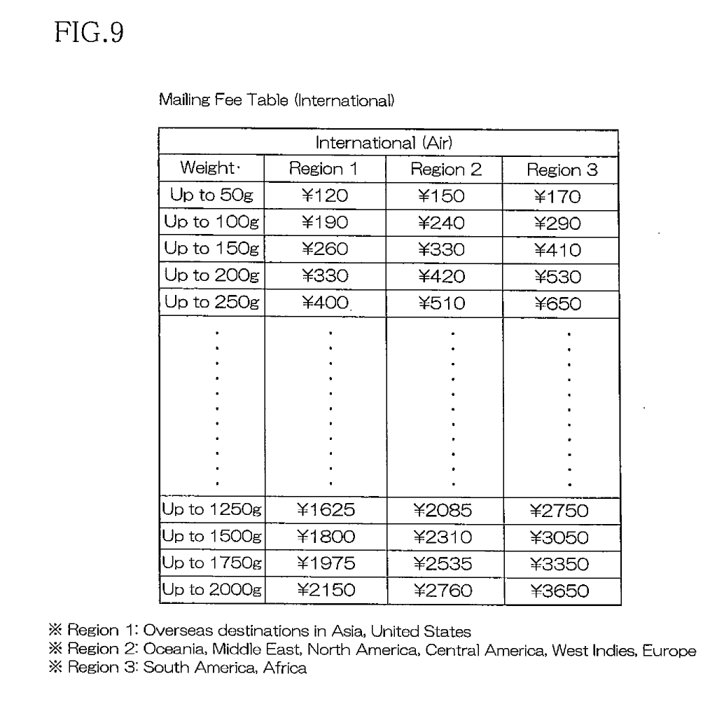

FIG. 8 illustrates an exemplary configuration of a mailing fee table (for domestic destinations) stored in the memory unit 108, and FIG. 9 illustrates an exemplary configuration of a mailing fee table (for international destinations) that is also stored in the memory unit 108. In case of international destinations, respective mailing fees are set up for three separate regions. It should be noted that while in this example uniform fees are set up for the entire country in case of domestic destinations, separate fees may be set up for remote islands.

Next, the electronic filing system of the above-described configuration will be specifically explained with the help of Exemplary Embodiment 1 used to calculate printing costs, Exemplary Embodiment 2 used to calculate fax transmission costs, Exemplary Embodiment 3 used to calculate e-mail transmission costs, and Exemplary Embodiment 4 used to calculate mailing costs.

### Exemplary Embodiment 1

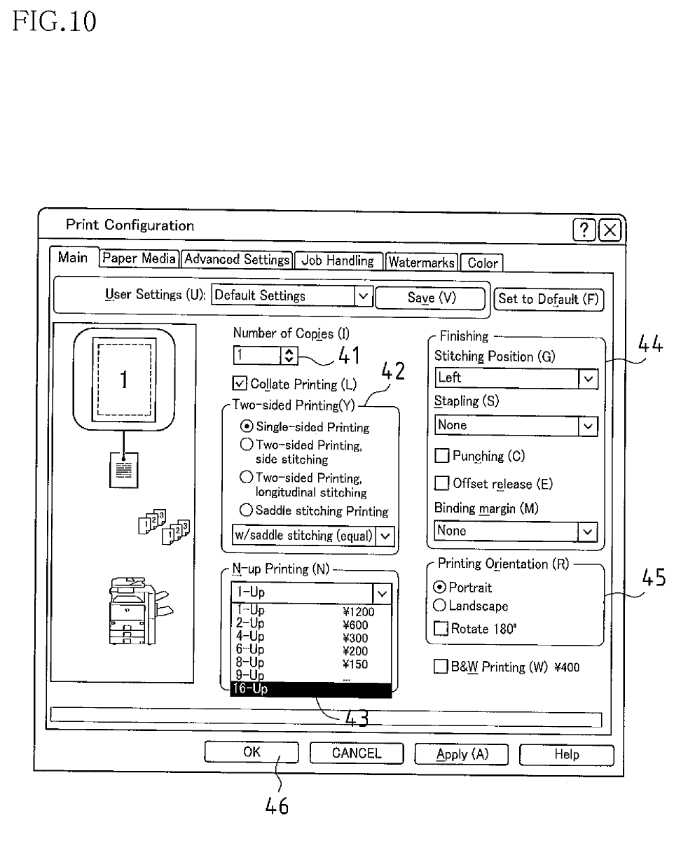

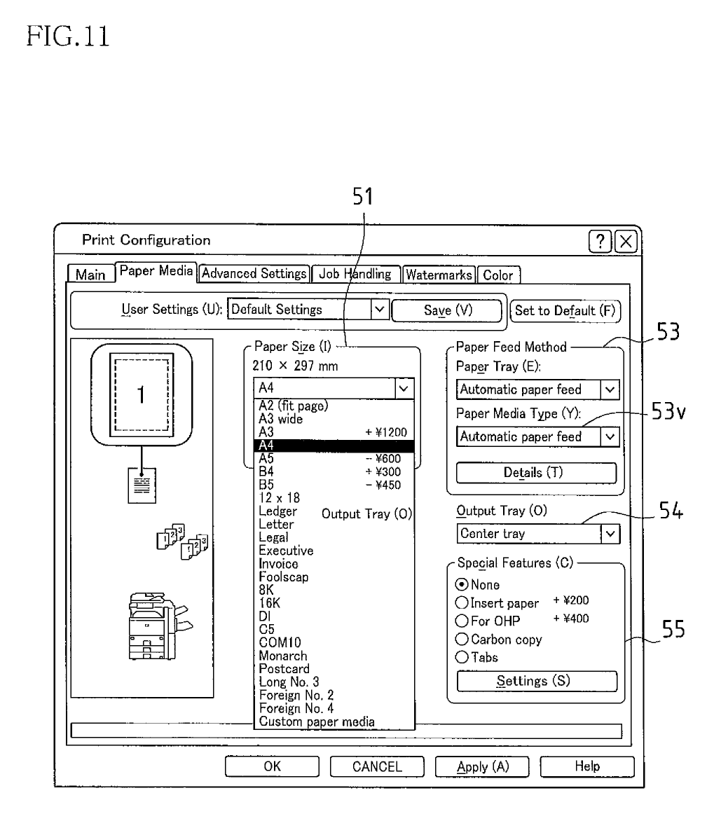

FIG. 10 and FIG. 11 are examples of print setup screens (user interface screens) used to set up the page processing method used during printing, with FIG. 10 showing an example of the main screen, and FIG. 11 showing an example of a paper media setup screen.

The print setup screen (main screen) illustrated in FIG. 10 is displayed when the page processing setup button 151 is depressed in case the printer selection button 154 has been depressed and the output mode has been set to “printing” on the user interface screen shown in FIG. 2. This print setup screen is provided with five fields, i.e. a copy number configuration field 41, a double faced print configuration field 42, an n-up print configuration field 43, a finishing configuration field 44, and a printing orientation configuration field 45. In the n-up print configuration field 43, the n-up printing mode selection window displays several types of page number configuration used to print 1-up, 2-up, 4-up, . . . , or 16-up on a single sheet of print media, with printing costs displayed next to these configurations. The printing fees displayed herein represent printing fees incurred when the respective values of the n-up printing settings are changed while the settings of the other configuration fields 41, 42, 44, and 45 remain the same as the currently displayed settings. While this embodiment makes use of an arrangement, in which the printing fees are displayed next to the configurations in the n-up printing mode selection window, the invention is not limited to such a display format. For example, by moving the cursor up and down in the n-up printing mode selection window, printing fees can be successively displayed in the tag format illustrated in FIG. 2 next to the configurations that the cursor is pointing to.

Moreover, the print setup screen (paper media setup screen) illustrated in FIG. 11 is displayed (opened) when the “Paper Media” tab of the print setup screen shown in FIG. 10 is selected. This print setup screen is provided with four fields, including a paper size configuration field 51, a paper feed method configuration field 53, an output tray configuration field 54, and a special feature configuration field 55. Additionally, multiple paper sizes, such as A2 (fit-page), A3 wide, A4, . . . , and custom paper, are displayed in the paper size configuration field 51, in its selection window, with the respective printing fees displayed next to these paper sizes (in this example, there are five sizes, from A3 to B5). The printing fees displayed herein represent printing fees incurred when the respective paper sizes are changed while the settings of the other configuration fields 53-55 remain the same as the currently displayed settings. The form, in which the printing costs are displayed, consists in displaying increments/decrements corresponding to the selected paper sizes. Namely, in this example, A4 is selected as the paper size, and, relative to size A4, there is an increment of +1200 yen when the size is changed to size A3, and a decrement of −600 yen etc. when it is changed to size A5. In addition, while this embodiment makes use of an arrangement, in which the printing fees are displayed next to the paper sizes in the paper size selection window, the invention is not limited to such a display format. For example, by moving the cursor up and down in the paper size selection window, printing fees can be successively displayed in the tag format illustrated in FIG. 2 next to the different paper sizes that the cursor is pointing to.

Moreover, changing paper type choices 53v in the paper feed method configuration field 53 in the print setup screen (paper media setup screen) illustrated in FIG. 11 makes it possible to select items such as “cardboard”, etc. Although in case of the print setup screen (paper media setup screen) illustrated in FIG. 11 an appropriate paper tray is selected in accordance with the paper size and paper type, configuration may be paper tray-based as well. In this case, due to the fact that the paper media physical parameter table shown in FIG. 7 is stored in the memory unit 108, the weight and thickness of the printed product can be computed using this paper media physical parameter table and presented to the user. It should be noted that the contribution of the toner to the weight and the error induced by compression in case of thickness, etc., are disregarded.

It should be noted that if, upon confirmation of the printing fee on the screen shown in FIG. 10 or FIG. 11, the user depresses an “OK” button 46 on the main screen shown in FIG. 10, the display goes back to the user interface screen shown in FIG. 2. In this case, printing based on the current settings starts immediately upon depression of the “EXECUTE” button 155 in the top right corner of the user interface screen.

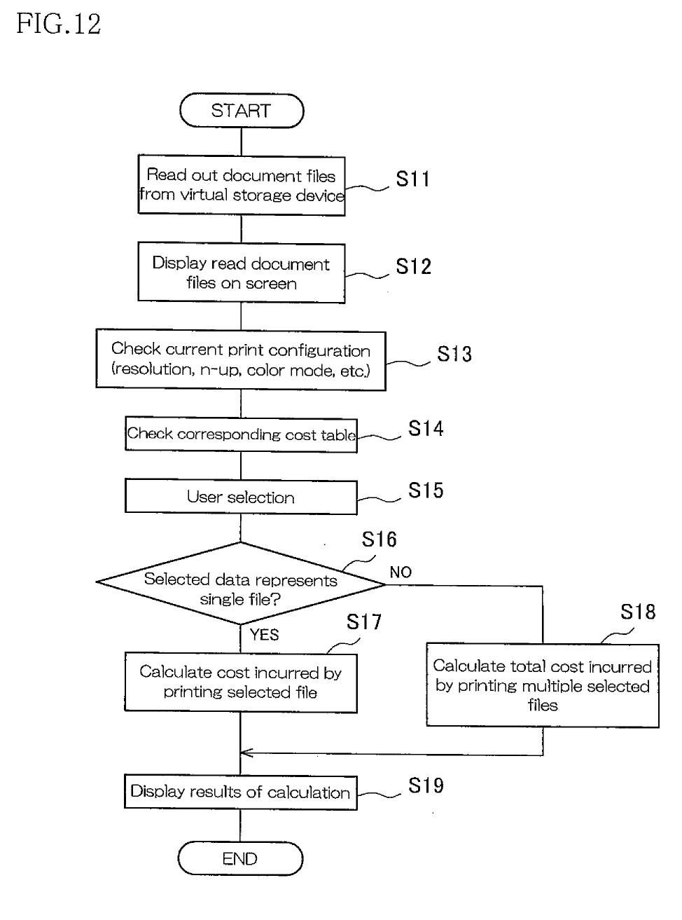

The basic processing procedure in the calculation of printing costs in the electronic filing system of the above-described configuration will be explained next with reference to the flow chart illustrated in FIG. 12. Here, we assume that the printing conditions have already been configured on the print setup screen shown in FIG. 10 or FIG. 11 described above, and that the configured printing conditions have already been stored in the configuration condition storage unit 109.

First of all, the document files saved in the storage devices, specifically, in the document database 101, are read out (Step S11) and all the read document files are displayed on the display unit 102 using icons representing “binders” (or “folders”), i.e. the storage devices, in accordance with the their storage structure (Step S12). The user interface screen shown in FIG. 2 is an example of this display. At such time, storage structures such as the cabinet and binders 11v, 11w, . . . are displayed as images only in the top left column 11 of the screen, with the bottom left column 12 of the screen and the right-hand column 13 of the screen remaining blank.

Subsequently, when the user clicks on the icon of an arbitrary binder 11v, 11w, . . . in the cabinet in this state, the document file selection unit 104 receives the input and selects the document files saved in the binder of the clicked icon and displays a list of the files in the bottom left column 12 of the screen. The user interface screen shown in FIG. 2 is an example of this display. As described above, the binder 11z, “Accounts”, is selected on this screen, and, furthermore, the file “Account Management Tables . . . ” is selected among the five files displayed in the bottom left column 12 of the screen and the tenth page of the “Account Management Tables . . . ” is displayed in the right-hand column 13 of the screen.

At such time, the cost calculation unit 105 refers to the configuration condition storage unit 109 to check the current print configuration conditions (resolution, color mode, paper media, etc.) already configured on the print setup screen shown in FIG. 10 or FIG. 11 (Step S13) and, along with that, refers to the printing cost table shown in FIG. 5 (Step S14).

On the other hand, the user selects document files that he or she intents to print on the user interface screen shown in FIG. 2 (Step S15). For instance, the user operates the mouse etc. of the operator input unit 103 to move the onscreen cursor (pointer) over the desired document file and clicks thereon. Upon receipt of the selection, the control unit 110 determines whether there is only one selected document file (Step S16). As a result, when there is only one selected document file (when the answer is “Yes” in Step S16), the control unit 110 uses the cost calculation unit 105 to calculate per-page printing costs for this single file based on the current print configuration contents stored in the configuration condition storage unit 109 and the printing costs (unit prices) listed in the printing cost table stored in the memory unit 108 (Step S17).

Specifically, when the selected document file is printed, a printing cost for the document file is calculated in the cost calculation unit 105 with the help of a module called a “virtual printer” by computing the number of pages produced in case of printing the document file under the pre-set print configuration conditions (stored in the configuration condition storage unit 109) and multiplying the number of pages by the printing costs (unit prices) corresponding to the same print configuration conditions stored in the printing cost table. For instance, when the document file 12x illustrated in FIG. 2 is selected and this document file 12x is printed in full color at a resolution of 300 dpi using A3 paper media (i.e. the print configuration conditions are “300 dpi, full-color, A3”), according to the printing cost table, the printing cost of 1 page at such time is ¥50/sheet (page). As can be seen from FIG. 2, the total number of pages in this document file 12x is 15 pages, and, therefore, the printing cost of this document file 12x at such time can be calculated as 50 (¥)×15 (sheets)=750 (¥).

On the other hand, when there are multiple selected document files (when the answer is “No” in Step S16), the control unit 110 uses the cost calculation unit 105 to calculate the total printing cost of these multiple selected files on a per-page basis based on the current print configuration contents stored in the configuration condition storage unit 109 and the printing costs (unit prices) listed in the printing cost table stored in the memory unit 108 (Step S18).

Specifically, when the selected multiple document files are printed, a total printing cost for the multiple document files is calculated in the cost calculation unit 105 with the help of a module called a “virtual printer” by computing the total number of pages produced in case of printing the multiple document files under the pre-set print configuration conditions (stored in the configuration condition storage unit 109) and multiplying the total number of pages by the printing costs (unit prices) corresponding to the same print configuration conditions stored in the printing cost table. For instance, when the three document files 12x, 12y, 12z illustrated in FIG. 3 are selected and these document files 12x, 12y, 12z are printed in full color at a resolution of 300 dpi using A3 paper media (i.e. the print configuration conditions are “300 dpi, full-color, A3”), according to the printing cost table, the printing cost of 1 page at such time is ¥50/sheet (page). Then, as can be seen from FIG. 3, the total number of pages in these document files 12x, 12y, 12z is 21 pages, and, therefore, the total printing cost of these three document files 12x, 12y, 12z at such time can be calculated as 50 (¥)×21 (sheets)=1050 (¥).

As shown in FIG. 3, the thus calculated printing costs are appended to the selected document files as costs required to print them, displayed in tag form (Step S19).

It should be noted that in the embodiment illustrated in FIG. 2 and FIG. 3 there are two kinds printing costs displayed, obtained when the color mode is both “black-and-white” and “color”. This is due to the fact that it is necessary to display printing costs prior to the selection of the color mode because the color mode, which is one of the print configuration conditions, is ultimately decided by the depression of either one of the “PRINT buttons” on a device having a user interface screen equipped with separate “PRINT” buttons for “black-and-white” and “color” printing, with the printing initiated simultaneously therewith. Therefore, in this case, the system will search the printing cost table shown in FIG. 5 for print configuration conditions corresponding to two conditions among the above-described print configuration conditions, i.e. “Resolution 300 dpi, Paper media A3”. As a result, two kinds of conditions, i.e. “300 dpi, full-color, A3” and “300 dpi, black-and-white, A3”, are selected as the corresponding print configuration conditions, the respective printing costs are calculated in the cost calculation unit 105 in accordance with these two types of conditions, and the calculation results are displayed in tag form illustrated in FIG. 2 and FIG. 3.

Moreover, once calculated, the results can be cached, and, when the same print target is selected under the same print configuration conditions, the calculation results can be retrieved from the cache.

Moreover, in the above-described Exemplary Embodiment 1, when a document file that one intends to print is selected from the bottom left column 12 of the screen on the user interface screen shown in FIG. 2, the selection is carried out by operating the mouse etc. of the operator input unit 103 to move the onscreen cursor (pointer) over the desired document file and clicking thereon; the system, however, may be configured to calculate the printing cost of the document file and display it in tag form when the cursor (pointer) is simply moved over the desired document file and allowed to remain there (i.e. if it simply points to the file). This enables the user to successively display the printing costs of the document files in tag form just by successively moving the cursor over the document files displayed in the bottom left column 12 of the screen shown in FIG. 2.

Furthermore, in the above-described Exemplary Embodiment 1, when selecting multiple document files that one wants to be printed, the desired document files are adapted to be selected in a successive manner from among the document files displayed in the bottom left column 12 of the screen on the user interface screen shown in FIG. 3; when, however, one wants to select all the document files displayed in the bottom left column 12 of the screen, all the document files in the corresponding binder 11z (that is, the binder storing the document files displayed in the bottom left column 12 of the screen) in the display of FIG. 3 may be adapted to be selected by moving the cursor (pointer) over the binder 11z and either clicking thereon or allowing it to remain there for a predetermined time (e.g. 1 second, etc.). The processing involved in the calculation of the printing cost in this case is the same as the processing explained in Step S18 above.

### Exemplary Embodiment 2

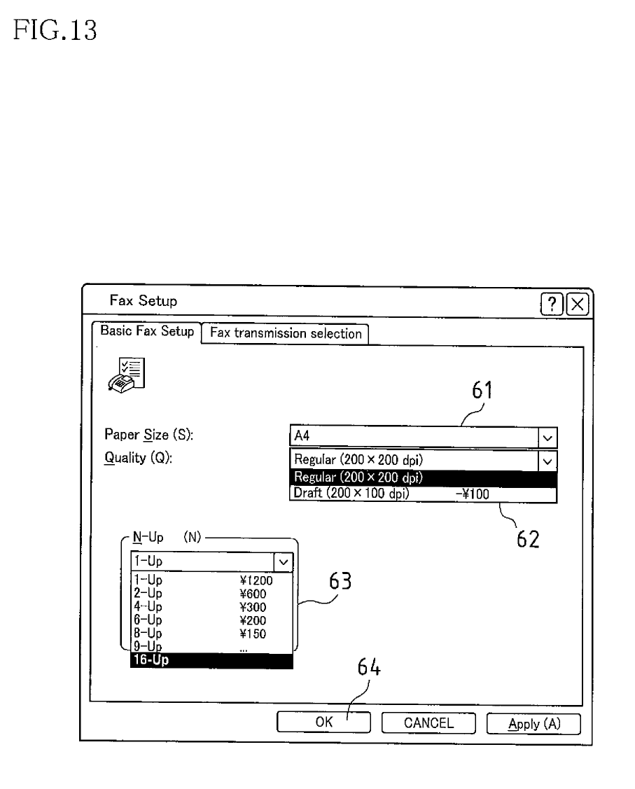

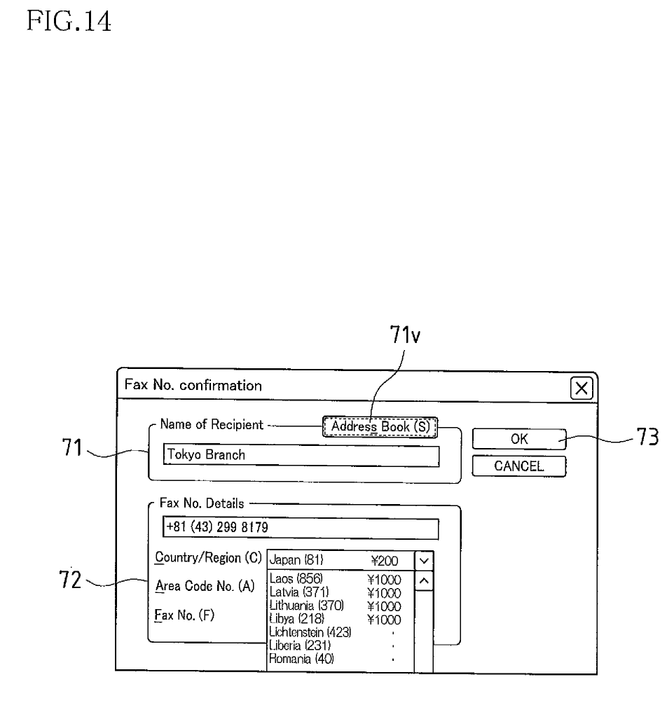

FIG. 13 and FIG. 14 are examples of fax setup screens used to set up the page processing method used during fax transmission, with FIG. 13 showing an example of a basic fax setup (page processing setup) screen, and FIG. 14 showing an example of a fax destination selection screen.

The basic setup screen shown in FIG. 13 is displayed when the page processing setup button 151 is depressed in case the fax destination selection button 152 has been depressed and the output mode has been set to “fax transmission” on the user interface screen shown in FIG. 2. This basic setup screen is provided with three fields, i.e. a paper size configuration field 61, an image quality configuration field 62, and an n-up configuration field 63. Now, in the n-up configuration field 63, the n-up mode selection window displays several types of page number configurations used to display pages 1-up, 2-up, 4-up, . . . , or 16-up on a single sheet of print media.

Moreover, the fax destination selection screen shown in FIG. 14 is displayed (opened) when the “Fax Transmission Selection” tab of the basic setup screen shown in FIG. 13 is selected. The fax destination selection screen is provided with two fields, i.e. a recipient name configuration field 71 and a fax number details configuration field 72. An arbitrary recipient name (e.g. the one used in the previous transmission) is then displayed in the recipient name configuration field 71, in its selection window. If necessary, the user may enter a recipient name into the field 71 directly. Moreover, an address book button 71v is also displayed in the recipient name configuration field 71 and depressing the address book button 71v displays the user's address book, allowing the user to select recipient names from the book. Here, if the recipient name set up in the recipient name configuration field 71 is registered in the address book, a fax number is automatically set up and displayed in the fax number details configuration field 72. On the other hand, if the recipient name set up in the recipient name configuration field 71 is not registered in the address book, a fax number is entered in the fax number details configuration field 72 by the user. Subsequently, when an “OK” button 73 on the fax destination selection screen is depressed, the display goes back to the basic setup screen shown in FIG. 13.

When the display returns to the basic setup screen shown in FIG. 13, fax transmission fees incurred when transmitting a fax in accordance with the above-described configuration contents are displayed next to the various configurations (1-up, 2-up, 4-up, . . . , 16-up) shown in the n-up configuration field 63 on the basic setup screen at such time. The fax transmission fees displayed herein represent fax transmission fees incurred when respectively changing the values of the n-up settings while the settings of the other configuration fields 61, 62, and 71 remain the same as the currently displayed settings. While this embodiment makes use of an arrangement, in which the fax transmission fees are displayed next to the configurations in the n-up mode selection window, the invention is not limited to such a display format. For example, by moving the cursor up and down in the n-up mode selection window, fax transmission fees can be successively displayed in the tag format illustrated in FIG. 2 next to the configurations that the cursor is pointing to.

It should be noted that when the user who has confirmed the fax transmission fee on the screen shown in FIG. 13 depresses an “OK” button 64 on the screen, the configured fax transmission conditions are set and the display goes back to the user interface screen shown in FIG. 2. A fax transmission based on the current settings starts immediately upon depression of the “EXECUTE” button 155 in the top right corner of the user interface screen.

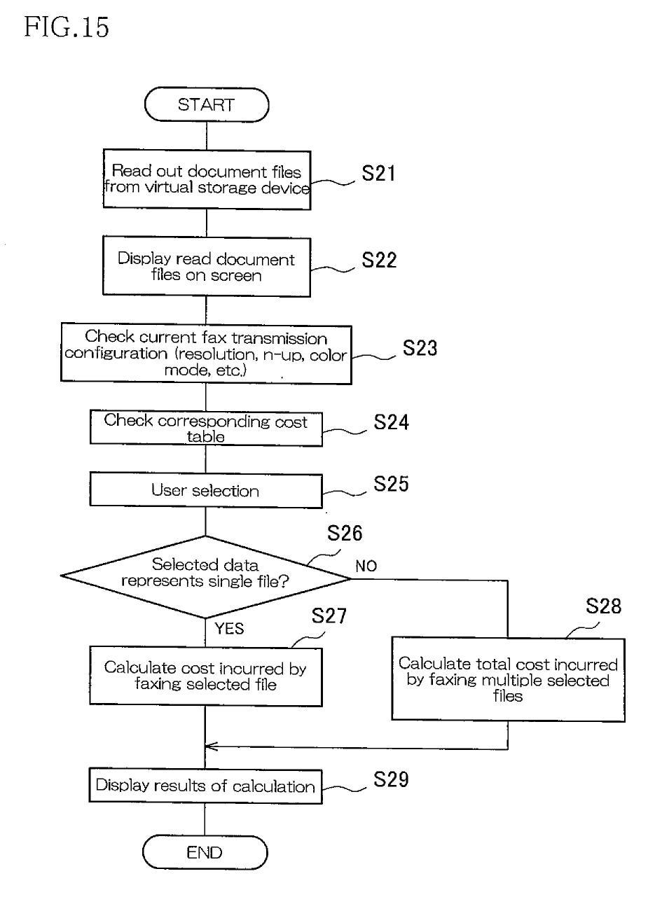

The processing procedure involved in the calculation of fax transmission costs in the electronic filing system of the above-described configuration will be explained next with reference to the flow chart illustrated in FIG. 15. Here, we assume that the fax transmission conditions have already been configured on the setup screen shown in FIG. 13 or FIG. 14 described above, and that the configured fax transmission conditions have already been stored in the configuration condition storage unit 109.

First of all, the document files saved in the storage devices, specifically, in the document database 101, are read out (Step S21) and all the read document files are displayed on the display unit 102 using icons representing “binders” (or “folders”), i.e. the storage devices, in accordance with their storage structure (Step S22). The user interface screen shown in FIG. 2 is an example of this display. At such time, storage structures such as the cabinet and binders 11v, 11w, . . . are displayed as images only in the top left column 11 of the screen, with the bottom left column 12 of the screen and the right-hand column 13 of the screen remaining blank.

Subsequently, when the user clicks on the icon of an arbitrary binder 11v, 11w, . . . in the cabinet in this state, the document file selection unit 104 receives the input and selects the document files saved in the binder of the clicked icon and displays a list of the files in the bottom left column 12 of the screen. The user interface screen shown in FIG. 2 is an example of this display. As described above, the binder 11z, “Accounts”, is selected on this screen, and, furthermore, the file “Account Management Tables . . . ” is selected among the five files displayed in the bottom left column 12 of the screen and the tenth page of the “Account Management Tables . . . ” is displayed in the right-hand column 13 of the screen.

At such time, the cost calculation unit 105 refers to the configuration condition storage unit 109 to check the current fax transmission configuration conditions (paper size, quality, n-up, etc.) already configured on the fax transmission setup screen shown in FIG. 13 or FIG. 14 (Step S23) and, along with that, refers to the communication cost table shown in FIG. 6 (Step S24).

On the other hand, the user selects document files that he or she intents to fax on the user interface screen shown in FIG. 2 (Step S25). For instance, the user operates the mouse etc. of the operator input unit 103 to move the onscreen cursor (pointer) over the desired document file and clicks thereon. Upon receipt of the selection, the control unit 110 determines whether there is only one selected document file (Step S26). As a result, when there is only one selected document file (when the answer is “Yes” in Step S26), the control unit 110 uses the cost calculation unit 105 to calculate a per-page fax communication cost of this single file based on the current fax transmission configuration contents stored in the configuration condition storage unit 109 and the transmission costs (unit prices) listed in the communication cost table stored in the memory unit 108 (Step S27).

Specifically, when the selected document file is faxed, a communication cost for the document file is calculated in the cost calculation unit 105 by computing the number of pages produced in case of faxing the document file under the pre-set fax transmission configuration conditions (stored in the configuration condition storage unit 109) and multiplying the number of pages by the communication costs (unit prices) corresponding to the same fax transmission configuration conditions stored in the communication cost table. For instance, when the document file 12x illustrated in FIG. 2 is selected and this document file 12x is faxed using A4 paper media at a resolution of 200 dpi, with G4 compression (i.e. the fax transmission configuration conditions are “200 dpi, A4, G4 compression”), according to the communication cost table, the fax communication cost of 1 page at such time is ¥2/sheet (page). Then, as can be seen from FIG. 2, the total number of pages in this document file 12x is 15 pages, and, therefore, the fax transmission cost of this document file 12x at such time can be calculated as 2 (¥)×15 (sheets)=30 (¥).

On the other hand, when there are multiple selected document files (when the answer is “No” in Step S26), the control unit 110 uses the cost calculation unit 105 to calculate the total communication cost of these multiple selected files on a per-page basis based on the current fax transmission configuration contents stored in the configuration condition storage unit 109 and the communication costs (unit prices) listed in the communication cost table stored in the memory unit 108 (Step S28).

Specifically, when the selected multiple document files are faxed, a total communication cost for the multiple document files is calculated in the cost calculation unit 105 by computing the total number of pages produced in case of faxing the multiple document files under the pre-set fax transmission configuration conditions (stored in the configuration condition storage unit 109) and multiplying the total number of pages by the communication costs (unit prices) corresponding to the same configuration conditions stored in the communication cost table. For instance, when the three document files 12x, 12y, 12z illustrated in FIG. 3 are selected and these document files 12x, 12y, 12z are transmitted using A4 paper media at a resolution of 400 dpi with G4 compression (i.e. the fax transmission configuration conditions are “400 dpi, A4, G4 compression”), according to the communication cost table, the communication cost of 1 page at such time is ¥8/sheet (page). Then, as can be seen from FIG. 3, the total number of pages in these document files 12x, 12y, 12z is 21 pages, and, therefore, the total communication cost of these three document files 12x, 12y, 12z at such time can be calculated as 8 (¥)×21 (sheets)=168 (¥).

As shown in FIG. 3, the thus calculated fax communication costs are appended to the selected document files as costs required to fax them and are displayed in tag form (Step S29). Here, as described above, FIG. 3 is an exemplary display shown in case of printing, not an exemplary display shown in case of faxing.

Moreover, once calculated, the results can be cached, and, when the same fax transmission target is selected under the same fax transmission configuration conditions, the calculation results can be retrieved from the cache.

Moreover, in the above-described Exemplary Embodiment 2, when a document file that one intends to fax is selected from the bottom left column 12 of the screen on the user interface screen shown in FIG. 2, the selection is carried out by operating the mouse etc. of the operator input unit 103 to move the onscreen cursor (pointer) over the desired document file and clicking thereon; the system, however, may be configured to calculate the fax communication cost of the document file and display it in tag form when the cursor (pointer) is simply moved over the desired document file and allowed to remain there (i.e. if it simply points to the file). This enables the user to successively display the fax communication costs of the document files in tag form just by successively moving the cursor over the document files displayed in the bottom left column 12 of the screen shown in FIG. 2.

Furthermore, in the above-described Exemplary Embodiment 2, when selecting multiple document files that one wants to fax, the desired document files are adapted to be selected in a successive manner from among the document files displayed in the bottom left column 12 of the screen on the user interface screen shown in FIG. 3; when, however, one wants to select all the document files displayed in the bottom left column 12 of the screen, all the document files in the corresponding binder 11z (that is, the binder storing the document files displayed in the bottom left column 12 of the screen) in the display of FIG. 3 may be adapted to be selected by moving the cursor (pointer) over the binder 11z and either clicking thereon or allowing it to remain there for a predetermined time (e.g. 1 second, etc.). The processing involved in the calculation of the fax communication cost in this case is the same as the processing explained in Step S28 above.

### Exemplary Embodiment 3

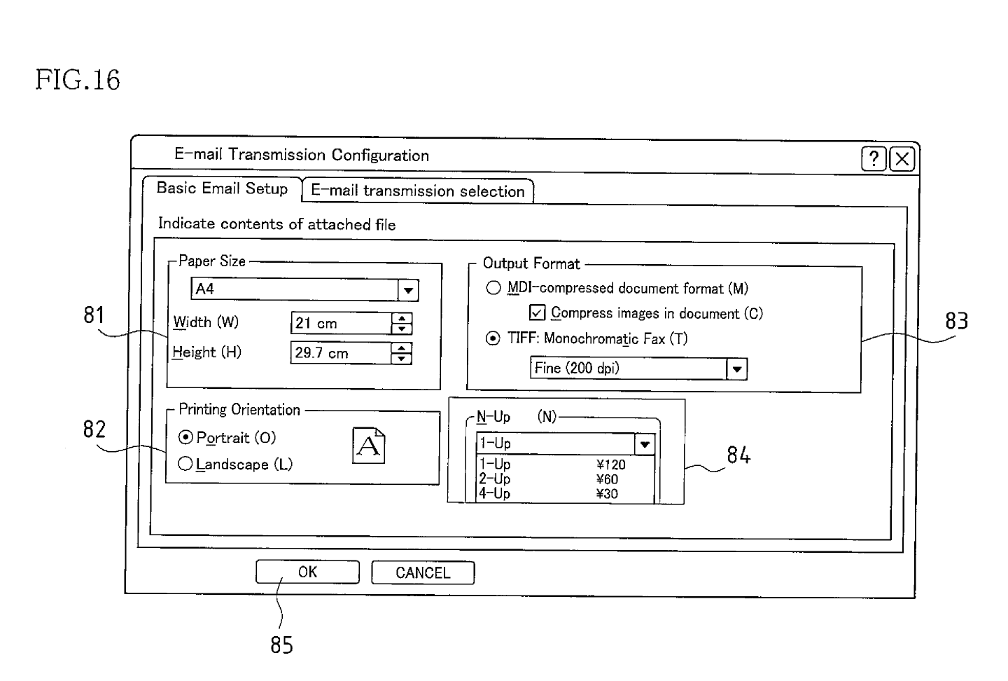

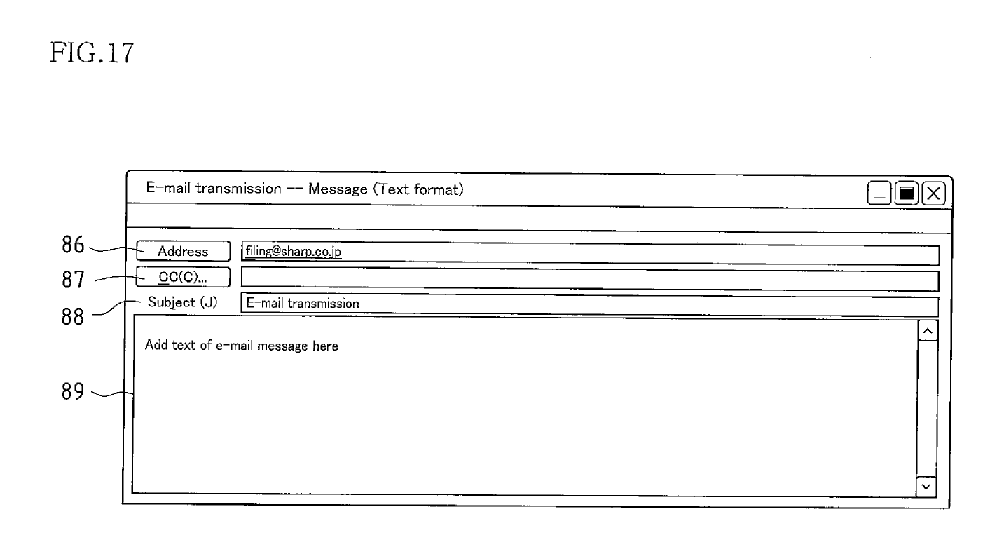

FIG. 16 and FIG. 17 are examples of e-mail setup screens used to set up the page processing method used during e-mail transmission, with FIG. 16 showing an example of a basic e-mail transmission setup (page processing setup) screen, and FIG. 17 showing an example of an e-mail destination selection screen.

The basic setup screen shown in FIG. 16 is displayed when the page processing setup button 151 is depressed in case the e-mail destination selection button 153 has been depressed and the output mode has been set to “e-mail transmission” on the user interface screen shown in FIG. 2. This basic setup screen is provided with four fields, i.e. a paper size configuration field 81, a printing orientation configuration field 82, an output format configuration field 83, and an n-up configuration field 84. Now, in the n-up configuration field 84, the n-up mode selection window displays several types of page number configurations used to display pages 1-up, 2-up, 4-up, . . . , or 16-up on a single sheet of print media.

Moreover, the e-mail destination selection screen shown in FIG. 17 is displayed (opened) when the “E-mail Transmission Selection” tab of the basic setup screen shown in FIG. 16 is selected. The e-mail destination selection screen is provided with four fields, i.e. an address configuration field 86, a CC(C) configuration field 87, a subject field 88, and a message body entry field 89. The user enters the e-mail address of the recipient in the address configuration field 86, the e-mail address of another recipient, if need be, in the CC(C) configuration field 87, the subject in the subject field 88, and, if necessary, text in the message body entry field 89. It should be noted that entries in the address configuration field 86 can be selected from an address book, not shown.

Subsequently, when the display returns to the basic setup screen shown in FIG. 16, e-mail transmission fees incurred when transmitting an e-mail in accordance with the above-described configuration contents are displayed next to the various configurations (1-up, 2-up, 4-up, . . . , 16-up) shown in the n-up configuration field 84 on the basic setup screen at such time. The e-mail transmission fees displayed herein represent e-mail transmission fees incurred when respectively changing the values of the n-up settings while the settings of the other configuration fields 81, 82, and 83 remain the same as the currently displayed settings. While this embodiment makes use of an arrangement, in which the e-mail transmission fees are displayed next to the configurations in the n-up mode selection window, the invention is not limited to such a display format. For example, by moving the cursor up and down in the n-up mode selection window, e-mail transmission fees can be successively displayed in the tag format illustrated in FIG. 2 next to the configurations that the cursor is pointing to.

It should be noted that when the user who has confirmed the e-mail transmission fee on the screen shown in FIG. 16 depresses an “OK” button 85 on the screen, the configured e-mail transmission conditions are set and the display goes back to the user interface screen shown in FIG. 2. An e-mail transmission based on the current settings starts immediately upon depression of the “EXECUTE” button 155 in the top right corner of the user interface screen.

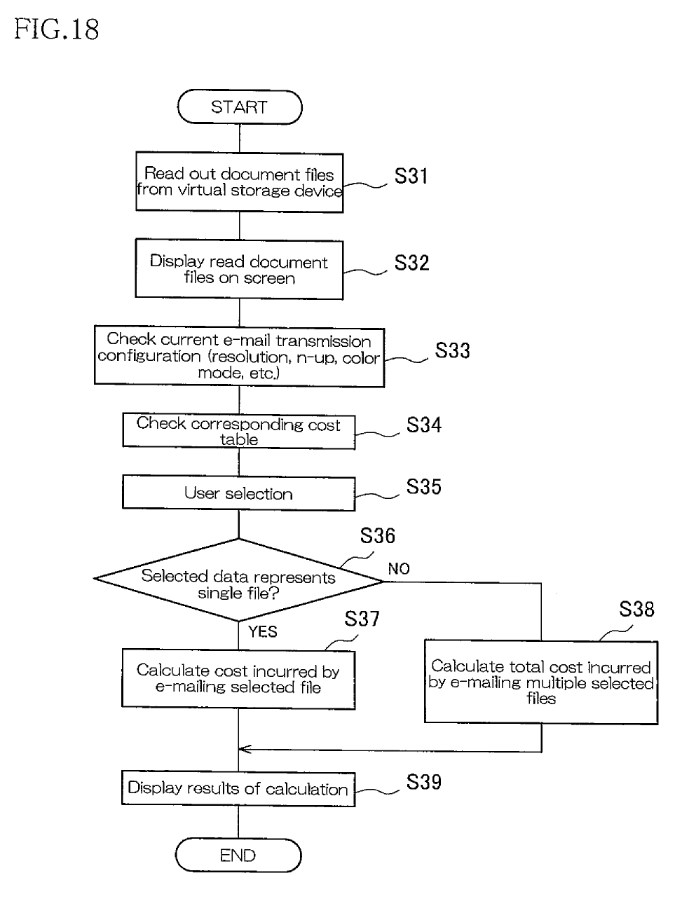

The processing procedure involved in the calculation of e-mail transmission costs in the electronic filing system of the above-described configuration will be explained next with reference to the flow chart illustrated in FIG. 18. Here, we assume that the e-mail transmission conditions have already been configured on the setup screen shown in FIG. 16 or FIG. 17 described above, and that the configured e-mail transmission conditions have already been stored in the configuration condition storage unit 109.

First of all, the document files saved in the storage devices, specifically, in the document database 101, are read out (Step S31) and all the read document files are displayed on the display unit 102 using icons representing “binders” (or “folders”), i.e. the storage devices, in accordance with their storage structure (Step S32). The user interface screen shown in FIG. 2 is an example of this display. At such time, storage structures such as the cabinet and binders 11v, 11w, . . . are displayed as images only in the top left column 11 of the screen, with the bottom left column 12 of the screen and the right-hand column 13 of the screen remaining blank.

Subsequently, when the user clicks on the icon of an arbitrary binder 11v, 11w, . . . in the cabinet in this state, the document file selection unit 104 receives the input and selects the document files saved in the binder of the clicked icon and displays a list of the files in the bottom left column 12 of the screen. The user interface screen shown in FIG. 2 is an example of this display. As described above, the binder 11z, “Accounts”, is selected on this screen, and, furthermore, the file “Account Management Tables . . . ” is selected among the five files displayed in the bottom left column 12 of the screen and the tenth page of the “Account Management Tables . . . ” is displayed in the right-hand column 13 of the screen.

At such time, the cost calculation unit 105 refers to the configuration condition storage unit 109 to check the current e-mail transmission configuration conditions (paper size, output format, n-up, etc.) already configured on the e-mail transmission setup screen shown in FIG. 16 or FIG. 17 (Step S33) and, along with that, refers to the communication cost table shown in FIG. 6 (Step S34).

On the other hand, the user selects document files that he or she intents to e-mail on the user interface screen shown in FIG. 2 (Step S35). For instance, the user operates the mouse etc. of the operator input unit 103 to move the onscreen cursor (pointer) over the desired document file and clicks thereon. Upon receipt of the selection, the control unit 110 determines whether there is only one selected document file (Step S36). As a result, when there is only one selected document file (when the answer is “Yes” in Step S36), the control unit 110 uses the cost calculation unit 105 to calculate a per-page communication cost of this single file based on the current e-mail transmission configuration contents stored in the configuration condition storage unit 109 and the transmission costs (unit prices) listed in the communication cost table stored in the memory unit 108 (Step S37).

Specifically, when the selected document file is e-mailed, a communication cost for the document file is calculated in the cost calculation unit 105 by computing the number of pages produced in case of e-mailing the document file under the pre-set e-mail transmission configuration conditions (stored in the configuration condition storage unit 109) and multiplying the number of pages by the communication costs (unit prices) corresponding to the same e-mail transmission configuration conditions stored in the communication cost table. For instance, when the document file 12x illustrated in FIG. 2 is selected and this document file 12x is e-mailed using A4 paper media at a resolution of 200 dpi, with G4 compression (i.e. the e-mail transmission configuration conditions are “200 dpi, A4, G4 compression”), according to the communication cost table, the e-mail transmission cost of 1 page at such time is ¥2/sheet (page). Then, as can be seen from FIG. 2, the total number of pages in this document file 12x is 15 pages, and, therefore, the e-mail communication cost of this document file 12x at such time can be calculated as 2 (¥)×15 (sheets)=30 (¥).

On the other hand, when there are multiple selected document files (when the answer is “No” in Step S36), the control unit 110 uses the cost calculation unit 105 to calculate the total communication cost of these multiple selected files on a per-page basis based on the current e-mail transmission configuration contents stored in the configuration condition storage unit 109 and the communication costs (unit prices) listed in the communication cost table stored in the memory unit 108 (Step S38).

Specifically, when the selected multiple document files are e-mailed, a total communication cost for the multiple document files is calculated in the cost calculation unit 105 by computing the total number of pages produced in case of e-mailing the multiple document files under the pre-set e-mail transmission configuration conditions (stored in the configuration condition storage unit 109) and multiplying the total number of pages by the communication costs (unit prices) corresponding to the same configuration conditions stored in the communication cost table. For instance, when the three document files 12x, 12y, 12z illustrated in FIG. 3 are selected and these document files 12x, 12y, 12z are transmitted using A4 paper media at a resolution of 400 dpi with G4 compression (i.e. the e-mail transmission configuration conditions are “400 dpi, A4, G4 compression”), according to the communication cost table, the communication cost of 1 page at such time is ¥8/sheet (page). Then, as can be seen from FIG. 3, the total number of pages in these document files 12x, 12y, 12z is 21 pages, and, therefore, the total communication cost of these three document files 12x, 12y, 12z at such time can be calculated as 8 (¥)×21 (sheets)=168 (¥).

As shown in FIG. 3, the thus calculated e-mail communication costs are appended to the selected document files as costs required to e-mail them and are displayed in tag form (Step S39). Here, as described above, FIG. 3 is an exemplary cost display shown in case of printing, not an exemplary cost display shown in case of e-mailing.

Moreover, once calculated, the results can be cached, and, when the same e-mail transmission target is selected under the same e-mail transmission configuration conditions, the calculation results can be retrieved from the cache.

Moreover, in the above-described Exemplary Embodiment 3, when a document file that one intends to e-mail is selected from the bottom left column 12 of the screen on the user interface screen shown in FIG. 2, the selection is carried out by operating the mouse etc. of the operator input unit 103 to move the onscreen cursor (pointer) over the desired document file and clicking thereon; the system, however, may be configured to calculate the e-mail communication cost of the document file and display it in tag form when the cursor (pointer) is simply moved over the desired document file and allowed to remain there (i.e. if it simply point to the file). This enables the user to successively display the e-mail communication costs of the document files in tag form just by successively moving the cursor over the document files displayed in the bottom left column 12 of the screen illustrated in FIG. 2.

Furthermore, in the above-described Exemplary Embodiment 3, when selecting multiple document files that one wants to e-mail, the desired document files are adapted to be selected in a successive manner from among the document files displayed in the bottom left column 12 of the screen on the user interface screen shown in FIG. 2 or FIG. 3; when, however, one wants to select all the document files displayed in the bottom left column 12 of the screen, all the document files in the corresponding binder 11z (that is, the binder storing the document files displayed in the bottom left column 12 of the screen) in the displays of FIG. 2 or FIG. 3 may be adapted to be selected by moving the cursor (pointer) over the binder 11z and either clicking thereon or allowing it to remain there for a predetermined time (e.g. 1 second, etc.). The processing involved in the calculation of the e-mail communication cost in this case is the same as the processing explained in Step S38 above.

### Exemplary Embodiment 4

Exemplary Embodiment 4 is an embodiment describing processing involved in the calculation of the cost of mailing of a printed product produced by printing in the above-described Exemplary Embodiment 1.

Because, as described above, the paper media physical parameter table shown in FIG. 7 is stored in the memory unit 108, the weight and thickness of the printed product can be computed using this paper media physical parameter table and presented to the user. The fees to be incurred when using a mailing service can be then calculated based on information on the computed weight and thickness and the mailing fee tables (domestic and international) shown in FIG. 8 and FIG. 9, which are stored in the memory unit 108.

Namely, under the fee computation method, a weight that corresponds to the type of envelope determined based on the thickness of the printed product and number of copies is added to the total weight of the printed product. Computation is then carried out based on the mailing fee tables shown in FIG. 8 and FIG. 9 (domestic and international) and on the destination (administrative divisions in Japan and abroad) selected by the user separately.

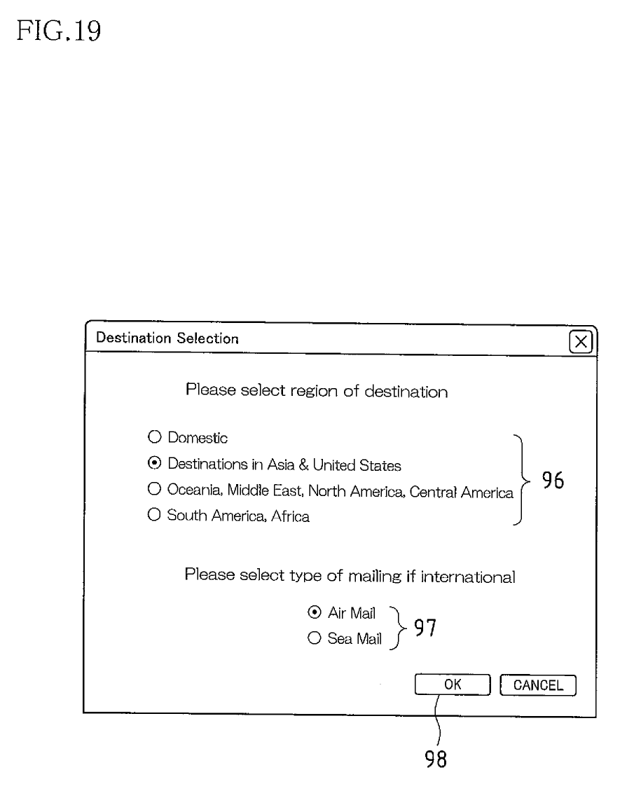

FIG. 19 is an exemplary configuration of a destination selection screen utilized when calculating the mailing fees.

The destination selection screen is provided with two fields, i.e. a region selection field 96, which is used to select the region of the destination, and a mailing type selection field 97. Namely, the user checks the checkbox of the desired region in the region selection field 96 and, if the destination is overseas, checks either the “Air Mail” or “Sea Mail” checkbox in the mailing type selection field 97. In this example, the item “Overseas destinations in Asia & United States (Region 1)” is checked as the destination (region), and “Air Mail” is checked as the type of mailing. Subsequently, the destination is set when an “OK” button 98 on the destination selection screen is depressed.

Specifically, for example, if a single copy of the document file 12x shown in FIG. 2 is printed, the total page number, as can be seen from FIG. 2, will be 15 pages. In this case, assuming that it is printed on fine-grade paper, the weight of a single A4 sheet of the printed product will be 5.125 g. Namely, according to the paper media physical parameter table shown in FIG. 7, the weight of 1 m² (10,000 cm²) of fine-grade paper is 82 g, and, since the size (surface area) of corresponding A4 paper media is 623.7 cm², the number of sheets of A4 paper media that can be obtained from 10,000 cm² is approximately 10,000/623.7=16 (sheets). Therefore, the weight of a single A4 sheet of the printed product will be 82 g/16=5.125 g. Consequently, the total weight of the printed document file 12x will be 5.125 g×15=76.875 g. With account taken of the added weight of the envelope (about 15 g), the total weight will be approximately 91.875 g and, in case of mailing to Region 1 (Overseas Destinations in Asia & United States) by air mail, the mailing fee corresponding to this weight, based on the mailing fee table shown in FIG. 9, will be ¥190.

### Exemplary Embodiment 5

Exemplary Embodiment 5 is an embodiment that permits simultaneous application of the above-described printing-related Exemplary Embodiment 1, fax transmission-related Exemplary Embodiment 2, e-mail transmission-related Exemplary Embodiment 3, and mailing-related Exemplary Embodiment 4. Namely, in the explanations provided regarding the above-described Exemplary Embodiments 1-4 we have assumed that the user configures all the condition-related settings via manual input; in Exemplary Embodiment 5, however, the configuration of the conditions is simplified. Here, explanations will be provided regarding a case, in which it is applied to printing.

In Exemplary Embodiment 5, when the user depresses the “EXECUTE” button 155 in a state, wherein arbitrary binders 11v, 11w, . . . or arbitrary folders 12v, 12w, . . . inside them for printing have been selected on the user interface screen shown FIG. 2 or FIG. 3, the control unit 110 acquires “Frequently Used Configurations” pre-registered by the user from among various combinations of parameters registered in the printing cost table shown in FIG. 5. It should be noted that while detailed explanations are omitted here, a registration setup screen used to perform such registration is arranged to be opened from a menu screen, not shown, thereby enabling the user to register “Frequently Used Configurations” using this registration setup screen.

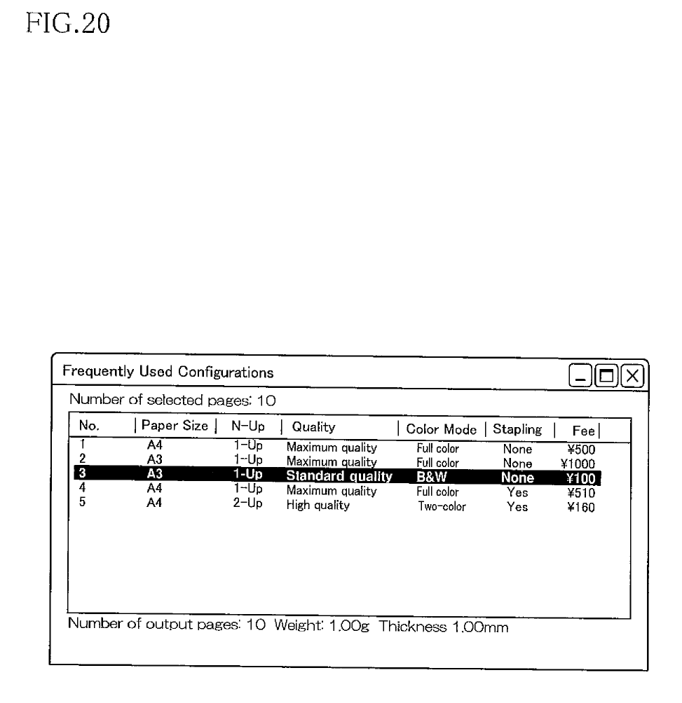

The control unit 110 obtains the respective printing fees resulting from applying each configuration contained in the “Frequently Used Configurations” to the arbitrary selected binders 11v, 11w, . . . or folders 12v, 12w, . . . and displays the results on screen in the form of a list. An example of the resulting display is illustrated in FIG. 20.

When the user selects a single item from this listing, printing starts immediately based on the selected configuration.

It should be noted that while in the explanations regarding Exemplary Embodiment 5 we have assumed that the “Frequently Used Configurations” are to be registered by the user in advance, the “Frequently Used Configurations” may be arranged to be extracted from past usage history. In other words, the contents of processing (condition-related settings) may be arranged to be saved in a special area of the memory unit 108 as past use history when the processing of the above-described Exemplary Embodiments 1-4 is performed, with several (for instance, top five, etc.) configurations having a high frequency of use adapted to be automatically extracted as “Frequently Used Configurations”. This makes it possible to always present the “Frequently Used Configurations” to the user in accordance with the user's actual usage.

### Exemplary Embodiment 6

Exemplary Embodiment 6 is another embodiment that permits simultaneous application of the above-described printing-related Exemplary Embodiment 1, fax transmission-related Exemplary Embodiment 2, e-mail transmission-related Exemplary Embodiment 3, and mailing-related Exemplary Embodiment 4 with account taken of providing a price cap when configuring the conditions.

In other words, the control unit 110 displays an input screen for price caps, not shown, when the user depresses the “EXECUTE” button 155 in the above-described Exemplary Embodiment 5. When the user enters a price cap on the input screen and depresses, e.g. a “SET” button, not shown, the control unit 110 acquires the “Frequently Used Configurations” pre-registered by the user and obtains the respective printing fees resulting from applying each of the configurations contained in the “Frequently Used Configurations”. The results that do not exceed the price cap entered by the user may be subject to selection to determine several top results adjacent the price cap, with these results displayed in the form of a list. Subsequently, when the user selects a single item from this listing, printing starts immediately based on the selected configuration.

The above-described electronic filing system according to the present invention can be advantageously utilized as a system that is applied, for instance, to copying, printing, faxing, and emailing-capable multi-functional peripherals installed in convenience stores etc., thereby enabling users to perform various types of printing, faxing, emailing, etc. with the help of the multi-functional peripherals installed in the convenience stores and, in addition, when printed matter is mailed from the convenience stores, notifies the users of the required fees in advance. In addition, when applied to the above-mentioned multi-functional peripherals installed on company premises, the electronic filing system of the present invention is effective in managing, for instance, the communication costs of each department.

The present invention can be implemented in a variety of other forms without departing from its spirit or essential features. For this reason, the above-described embodiments are to all intents and purposes merely illustrative and should not be construed as limiting. The scope of the present invention is defined by the claims and is not restricted by the descriptions of the specification in any way. Furthermore, all variations and modifications of the claims within the scope of equivalency fall within the purview of the present invention.

What is claimed is:

1. An electronic filing system provided with a document file presentation means for presenting a list of saved document files to a user, the electronic filing system comprising:
a printing cost table specifying printing costs according to print configuration conditions, and
a printing cost calculation means for calculating printing costs by referring to the printing cost table,
wherein the printing cost calculation means refers to the printing cost table to calculate printing costs corresponding to a current print configuration in association with icons of the document files displayed as the list by the document file presentation means and displays the calculated printing costs as the printing costs of the document files corresponding to the icons.

2. The electronic filing system according to claim 1 provided with a storage device presentation means for presenting the user with a list of storage devices used to group and store the saved document files, the electronic filing system comprising:
the printing cost table specifying printing costs according to print configuration conditions and
the printing cost calculation means for calculating printing costs by referring to the printing cost table,
wherein the printing cost calculation means refers to the printing cost table to calculate printing costs corresponding to the current print configuration in association with icons of the storage devices displayed as the list by the storage device presentation means and displays the calculated printing costs as the printing costs of all the document files contained in the storage devices.

3. The electronic filing system according to claim 1,
wherein simultaneous selection of multiple icons is possible by successively pointing to some or all of the multiple icons displayed as the list and a total printing cost incurred when printing all the multiple documents corresponding to the group of selected icons is displayed.

4. The electronic filing system according to claim 2,
wherein simultaneous selection of multiple icons is possible by successively pointing to some or all of the multiple icons displayed as the list and a total printing cost incurred when printing all the multiple documents corresponding to the group of selected icons is displayed.

5. The electronic filing system according to claim 1,
wherein all the documents corresponding to single or multiple icons selected by the user from the listing display are batch printed.

6. The electronic filing system according to claim 2,
wherein all the documents corresponding to single or multiple icons selected by the user from the listing display are batch printed.

7. The electronic filing system according to claim 3,
wherein all the documents corresponding to single or multiple icons selected by the user from the listing display are batch printed.

8. The electronic filing system according to claim 4,
wherein all the documents corresponding to single or multiple icons selected by the user from the listing display are batch printed.

9. The electronic filing system according to claim 1,
wherein information on the number of pages output when the documents corresponding to the group of selected icons are printed out under the current print configuration is displayed.

10. The electronic filing system according to claim 1,
wherein information on the thickness and weight of all the paper media output when the documents corresponding to the group of selected icons are printed out under the current print configuration is displayed.

11. The electronic filing system according to claim 1,
wherein costs incurred when the paper media that have been printed out are placed in an envelope and mailed using a mailing service are displayed as well.

12. An electronic filing system provided with a document file presentation means for presenting a list of saved document files to a user, the electronic filing system comprising:
a communication cost table specifying communication costs according to communication configuration conditions, and
a communication cost calculation means for calculating communication costs by referring to the communication cost table,
wherein the communication cost calculation means refers to the communication cost table to calculate communication costs corresponding to the current communication configuration in association with icons of the document files displayed as the list by the document file presentation means and displays the calculated communication costs as the communication costs of the document files corresponding to the icons.

13. The electronic filing system according to claim 12 provided with a storage device presentation means for presenting the user with a list of storage devices used to group and store the saved document files, the electronic filing system comprising:
the communication cost table specifying communication costs according to communication configuration conditions, and
the communication cost calculation means for calculating communication costs by referring to the communication cost table,
wherein the communication cost calculation means refers to the communication cost table to calculate communication costs corresponding to the current communication configuration in association with icons of the storage devices displayed as the list by the storage device presentation means and displays the calculated communication costs as the communication costs of all the document files contained in the storage devices.

14. The electronic filing system according to claim 2,
wherein a size of the displayed icons is displayed by reducing or increasing the size in accordance with an internal volume of the storage devices.

15. The electronic filing system according to claim 1,
wherein, when costs required for an execution of various jobs are displayed, costs incurred when, for each of the several different job configurations selected and registered by the user in advance, a job is executed under the job configuration, are displayed as a list, and parameter groups of the job configuration are automatically set up and job execution is initiated when the user selects one of the job configurations.

16. The electronic filing system according to claim 15,
wherein combinations of parameter settings permitting job execution on selected documents are presented in accordance with a fee cap designated by the user in advance.

17. The electronic filing system according to claim 1,
wherein, on a user interface utilized for configuring various job and parameter settings and comprising pull-down menus, radio buttons, and check boxes, in addition to titles of respective selectable values, job execution fees associated with combinations of parameters applied in cases where the configuration settings are changed to the values are displayed.

18. The electronic filing system according to claim 1,
wherein, on a user interface utilized for configuring various job and parameter settings and comprising pull-down menus, radio buttons, and check boxes, in addition to titles of respective selectable values, fee differentials relative to pre-adjustment job execution fees associated with combinations of parameters applied in cases where the configuration settings are changed to the values are displayed.
